(19) United States
(12) Patent Application Publication
(10) Pub. No.: US 2026/0189816 A1
(43) Pub. Date: Jul. 2, 2026

(54) SENSING DATA PROCESSING APPARATUS, SENSING DATA PROCESSING METHOD, AND ELECTRONIC DEVICE

(71) Applicant: SONY SEMICONDUCTOR SOLUTIONS CORPORATION, KANAGAWA (JP)

(72) Inventor: YASUO KANDA, KANAGAWA (JP)

(21) Appl. No.: 19/125,481

(22) PCT Filed: Oct. 13, 2023
(86) PCT No.: PCT/JP2023/037125

§ 371 Date: Apr. 29, 2025

(30) Foreign Application Priority Data
Nov. 7, 2022 (JP) 2022-178382

(51) Int. Cl. H04N 25/677; G01K 3/00; G01K 7/01; H04N 17/00

(52) U.S. Cl. CPC H04N 25/677; G01K 3/005; G01K 7/01; H04N 17/002

(57) ABSTRACT

There is provided a sensing data processing apparatus including a conversion unit that acquires sensing data output from a sensing unit including a plurality of sensor elements arranged in a two-dimensional array, converts the sensing data into digital data, and outputs the digital data as information data, an encoder that performs error correcting encoding on the information data and generates redundant data, and a control unit that dynamically changes data amounts of the information data and the redundant data on a basis of temperature data acquired from a temperature sensor provided in the sensing unit.

### FIELD

The present disclosure relates to a sensing data processing apparatus, a sensing data processing method, and an electronic device.

### BACKGROUND

For example, like an imaging apparatus having a plurality of imaging elements that detect visible light, a sensing apparatus having a plurality of detection elements arranged in an array can acquire sensing data detected by each detection element. Furthermore, such a sensing apparatus includes a memory for storing acquired sensing data and the like, and the sensing data stored in the memory is subjected to predetermined data processing and is output as data in another form such as an image. For example, examples of an imaging apparatus having such a memory include imaging apparatus disclosed in Patent Document 1 and Patent Document 2 below.

### CITATION LIST

### Patent Literature

Patent Literature 1: JP 2013-93685 A
Patent Literature 2: JP 2020-31256 A

### SUMMARY

### Technical Problem

By the way, in recent years, the number of elements mounted on a sensing device has increased due to development of a technology that enables miniaturization and the like of a detection element, and accordingly, the data amount of sensing data acquired by the sensing apparatus has dramatically increased.

In addition, in a use situation where high quality is required for information obtained by processing sensing data, processing for detecting an error in the sensing data and correcting an error portion may be required. Therefore, in the sensing apparatus, in order to detect an error in the sensing data and correct the detected error portion, an error correcting code corresponding to the sensing data is generated, and the error correction code is added to the sensing data. Then, for example, the data processing unit can perform predetermined processing on the sensing data to which the error correcting code is added to convert the sensing data into information of another form satisfying desired quality.

That is, the data processing unit handles a large amount of data when processing sensing data, and it is difficult to avoid an increase in processing load.

Therefore, the present disclosure proposes a sensing data processing apparatus, a sensing data processing method, and an electronic device capable of suppressing an increase in the amount of data while maintaining the quality of data.

### Solution to Problem

According to the present disclosure, there is provided a sensing data processing apparatus including: a conversion unit that acquires sensing data output from a sensing unit including a plurality of sensor elements arranged in a two-dimensional array, converts the sensing data into digital data, and outputs the digital data as information data; an encoder that performs error correcting encoding on the information data and generates redundant data; and control unit that dynamically changes data amounts of the information data and the redundant data on a basis of temperature data acquired from a temperature sensor provided in the sensing unit.

Furthermore, according to the present disclosure, there is provided a method for sensing data processing including: acquiring sensing data output from a sensing unit including a plurality of sensor elements arranged in a two-dimensional array, converting the sensing data into digital data, and outputting the digital data as information data; performing error correcting encoding on the information data and generating redundant data; and dynamically changing data amounts of the information data and the redundant data on a basis of temperature data acquired from a temperature sensor provided in the sensing unit, by a sensing data processing apparatus.

Furthermore, according to the present disclosure, there is provided an electronic device on which a sensing data processing apparatus is mounted. In the electronic device, the sensing data processing apparatus includes: a conversion unit that acquires sensing data output from a sensing unit including a plurality of sensor elements arranged in a two-dimensional array, converts the sensing data into digital data, and outputs the digital data as information data; an encoder that performs error correcting encoding on the information data and generates redundant data; and a control unit that dynamically changes data amounts of the information data and the redundant data on a basis of temperature data acquired from a temperature sensor provided in the sensing unit.

### BRIEF DESCRIPTION OF DRAWINGS

FIG. 1 is an explanatory diagram illustrating a planar configuration example of an imaging apparatus of a comparative example.

FIG. 2 is an explanatory diagram illustrating a functional configuration example of the imaging apparatus of the comparative example.

FIG. 3 is an explanatory diagram schematically illustrating an embodiment of the present disclosure.

FIG. 4 is an explanatory diagram illustrating a functional configuration example of an imaging apparatus of an embodiment of the present disclosure.

FIG. 5 is an explanatory diagram illustrating a functional configuration example of a memory unit of an embodiment of the present disclosure.

FIG. 6 is an explanatory diagram illustrating a functional configuration example of a thermometer of an embodiment of the present disclosure.

FIG. 7 is a flowchart (part 1) illustrating an operation example of the imaging apparatus of an embodiment of the present disclosure.

FIG. 8 is a flowchart (part 2) illustrating an operation example of the imaging apparatus of an embodiment of the present disclosure.

FIG. 9 is an explanatory diagram schematically illustrating a modification of an embodiment of the present disclosure.

FIG. 10 is an explanatory diagram illustrating a stacked configuration example of an imaging apparatus of an embodiment of the present disclosure.

FIG. 11 is an explanatory diagram illustrating an example of an appearance of a monitoring camera.

FIG. 12 is an explanatory diagram illustrating an example of a schematic functional configuration of the monitoring camera.

FIG. 13 is a block diagram illustrating an example of a schematic functional configuration of a smartphone.

FIG. 14 is a block diagram depicting an example of schematic configuration of a vehicle control system.

FIG. 15 is a diagram of assistance in explaining an example of installation positions of an outside-vehicle information detecting section and an imaging section.

### DESCRIPTION OF EMBODIMENTS

Hereinafter, preferred embodiments of the present disclosure will be described in detail with reference to the accompanying drawings. Note that, in the present specification and the drawings, components having substantially the same functional configuration are denoted by the same reference numerals, and redundant description is omitted. Furthermore, in the specification and the drawings, a plurality of constituent elements having substantially the same or similar functional configuration may be distinguished from one another by adding different alphabets after the same reference numeral. However, if it is not necessary to distinguish the plurality of constituent elements having substantially the same or similar functional configuration from one another, only the same reference numeral is given.

In addition, the drawings referred to in the following description are drawings for promoting the description and understanding of an embodiment of the present disclosure, and shapes, dimensions, ratios, and the like illustrated in the drawings may be different from actual ones for the sake of clarity. Furthermore, the imaging apparatus illustrated in the drawings can be appropriately modified in design in consideration of the following description and known techniques.

An embodiment of the present disclosure described below is applied to an imaging apparatus as an example of a sensing unit. However, the embodiment of the present disclosure is not limited to being applied to such an imaging apparatus, and can be applied to various sensing units.

Note that the description will be given in the following order.
1. Background to Creation of Embodiment of Present Disclosure
1.1 Planar Configuration of Imaging Apparatus
1.2 Functional Configuration of Imaging Apparatus
1.3 Background
2. Embodiment
2.1 Detailed Configuration
2.2 Operation Example of Imaging Apparatus
2.3 Stacked Structure Example
3. Summary
1 4. Application Example
4.1 Application Example to Monitoring Camera
4.2 Application Example to Smartphone
4. 3 Application Example to Mobile Body
5. Supplement

### 1. Background to Creation of Embodiment of Present Disclosure

First, before describing the embodiment of the present disclosure, the background leading to the creation of the embodiment of the present disclosure by the present inventor will be described.

### 1.1 Planar Configuration of Imaging Apparatus

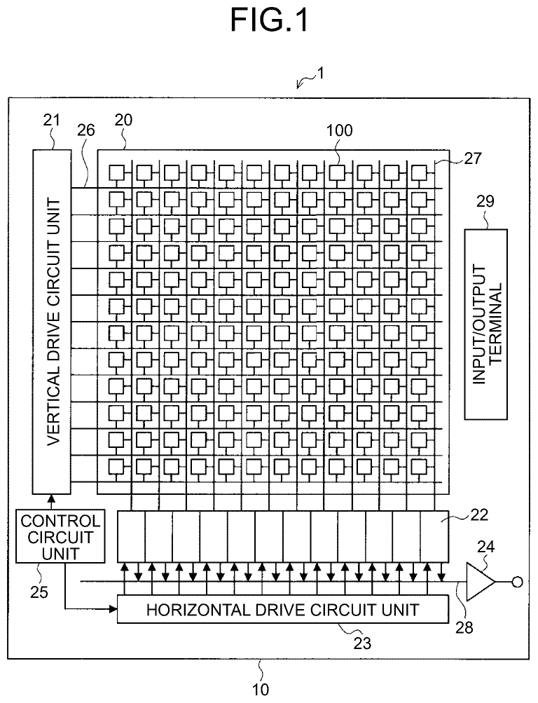

First, a planar configuration of an imaging apparatus 1 of a comparative example will be described with reference to FIG. 1. FIG. 1 is an explanatory diagram illustrating a planar configuration example of the imaging apparatus 1 of the comparative example. Note that, here, the comparative example means the imaging apparatus 1 studied by the inventor before creating the embodiment of the present disclosure.

As illustrated in FIG. 1, the imaging apparatus 1 of the comparative example includes a pixel array unit 20 in which a plurality of imaging elements 100 is arranged in a matrix on a substrate 10 made of, for example, silicon, and a peripheral circuit unit provided so as to surround the pixel array unit 20. Furthermore, the imaging apparatus 1 includes, as the peripheral circuit unit, a vertical drive circuit unit 21, a column signal processing unit 22, a horizontal drive circuit unit 23, an output circuit unit 24, a control circuit unit 25, and the like. Hereinafter, details of each block of the imaging apparatus 1 will be described.

### Pixel Array Unit 20

The pixel array unit 20 includes a plurality of imaging elements 100 two-dimensionally arranged in a matrix (array) along the row direction and the column direction on the substrate 10. Each imaging element 100 is an element that performs photoelectric conversion on incident light, and includes a photoelectric conversion unit (not illustrated) and a plurality of pixel transistors (for example, metal-oxide-semiconductor (MOS) transistors) (not illustrated). Then, the pixel transistor includes, for example, four transistors of a transfer transistor, a selection transistor, a reset transistor, and an amplification transistor. Furthermore, in the pixel array unit 20, for example, the plurality of imaging elements 100 is two-dimensionally arranged according to the Bayer array. Here, the Bayer array is an array pattern in which the imaging elements 100 that detect light having a green wavelength (for example, a wavelength of 495 nm to 570 nm) and generate charges are arranged in a checkered pattern, and the imaging elements 100 that detect light having a red wavelength (for example, a wavelength of 620 nm to 750 nm) and generate charges and the imaging elements 100 that detect light having a blue wavelength (for example, a wavelength of 450 nm to 495 nm) and generate charges are alternately arranged in the remaining portion for each line.

### Vertical Drive Circuit Unit 21

The vertical drive circuit unit 21 is formed by, for example, a shift register, selects a pixel drive line 26, supplies a pulse for driving the imaging elements 100 to the selected pixel drive line 26, and drives the imaging elements 100 in units of rows. That is, the vertical drive circuit unit 21 selectively scans each imaging element 100 of the pixel array unit 20 sequentially in the vertical direction (vertical direction in FIG. 1) in units of rows, and supplies a pixel signal based on a signal charge generated according to the amount of light received by a photoelectric conversion unit (not illustrated) of each imaging element 100 to a column signal processing unit 22 described later through a vertical signal line 27.

### Column Signal Processing Unit 22

The column signal processing unit 22 is arranged for each column of the imaging elements 100, and performs signal processing such as noise removal for each pixel column on the pixel signal based on the charge output from the imaging elements 100 for one row. For example, the column signal processing unit 22 performs signal processing such as correlated double sampling (CDS) and analog-digital (AD) conversion in order to remove fixed pattern noise unique to pixels, and outputs a pixel signal subjected to the signal processing.

### Horizontal Drive Circuit Unit 23

The horizontal drive circuit unit 23 is formed by, for example, a shift register, sequentially selects each of the column signal processing units 22 by sequentially outputting horizontal scanning pulses, and causes each of the column signal processing units 22 to output a pixel signal to a horizontal signal line 28.

### Output Circuit Unit 24

The output circuit unit 24 performs signal processing on the pixel signals sequentially supplied from each of the column signal processing units 22 described above through the horizontal signal line 28, and outputs the processed signals. The output circuit unit 24 may function as, for example, a functional unit that performs buffering, or may perform processing such as black level adjustment, column variation correction, and various digital signal processing. Note that buffering refers to temporarily storing pixel signals in order to compensate for differences in processing speed and transfer speed when pixel signals are exchanged. Furthermore, an input/output terminal 29 is a terminal for exchanging signals with an external device.

### Control Circuit Unit 25

The control circuit unit 25 receives an input clock and data instructing an operation mode and the like, and outputs data such as internal information of the imaging apparatus 1. That is, in the control circuit unit 25, a clock signal or a control signal serving as a reference of operations of the vertical drive circuit unit 21, the column signal processing unit 22, the horizontal drive circuit unit 23, and the like is generated on the basis of the vertical synchronization signal, the horizontal synchronization signal, and the master clock. Then, the control circuit unit 25 outputs the generated clock signal and control signal to the vertical drive circuit unit 21, the column signal processing unit 22, the horizontal drive circuit unit 23, and the like.

### 1.2 Functional Configuration of Imaging Apparatus

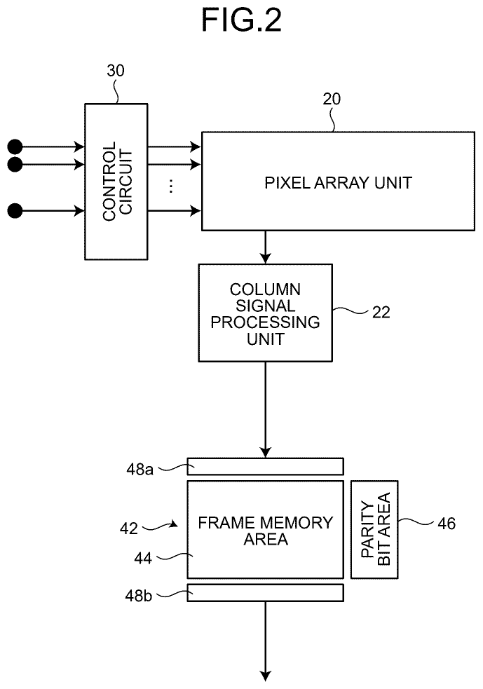

As described above, the imaging apparatus 1 can include a memory unit for storing the pixel signals described above. Furthermore, since the image generated by the imaging apparatus 1 is required to satisfy a desired quality, the pixel signal used in generating the image is required to have a low error rate. Therefore, the imaging apparatus 1 includes an error correcting code generation unit (hereinafter, referred to as an ECC generation unit) that generates an error correcting code so as to detect and correct an error that occurs when the pixel signal is acquired and output. Hereinafter, a functional configuration of the imaging apparatus 1 of the comparative example will be described with reference to FIG. 2. FIG. 2 is an explanatory diagram illustrating a functional configuration example of the imaging apparatus 1 of the comparative example.

As illustrated in FIG. 2, the imaging apparatus 1 includes a control circuit 30 (generic term for the vertical drive circuit unit 21, the horizontal drive circuit unit 23, and the control circuit unit 25) that controls the pixel array unit 20 and the like, and the column signal processing unit 22 that converts the pixel signal from the pixel array unit 20 into a digital signal, together with the pixel array unit 20, as described above. Note that, in the present specification, the pixel array unit 20, the control circuit 30, and the column signal processing unit 22 may be collectively referred to as a sensing unit.

Furthermore, the imaging apparatus 1 includes an ECC generation unit 48a that performs error correcting encoding on the pixel signal (information data) output from the column signal processing unit 22 and generates an error correcting code (parity) (redundant data). Furthermore, the imaging apparatus 1 includes a memory unit 42 that stores a pixel signal and an error correcting code. Specifically, the memory unit 42 includes a frame memory area 44 for storing a pixel signal and a parity bit area 46 for storing an error correcting code. Furthermore, the imaging apparatus 1 includes an ECC generation unit 48b that performs error correcting encoding on output data and generates an error correcting code (parity) when outputting data from the memory unit 42. Further, an error correcting code is further added to the pixel signal output from the memory unit 42 by the ECC generation unit 48b, and the pixel signal is output to an image processing unit (not illustrated). Then, the output pixel signal is subjected to predetermined processing by the image processing unit, and is output in the form of an image.

### 1.3 Background

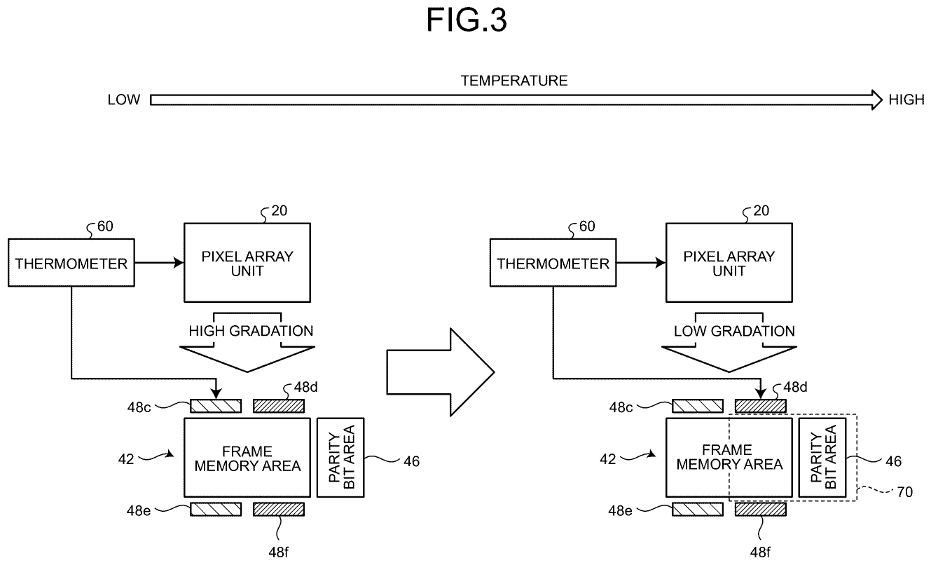

Next, before describing the embodiment of the present disclosure, the background leading to the creation of the embodiment of the present disclosure by the present inventor will be described with reference to FIG. 3. FIG. 3 is an explanatory diagram schematically illustrating the embodiment of the present disclosure.

For example, in a high-temperature environment, noise is likely to occur in the imaging element 100 of the pixel array unit 20, or a pixel signal is likely to be saturated (overexposure), so that image quality may deteriorate. Furthermore, in general, a memory element (not illustrated) used in the memory unit 42 also tends to deteriorate data retention in a high-temperature environment.

Therefore, in the imaging apparatus 1 of the comparative example, the ECC generation unit 48 is mounted, and an error correcting code is added to the pixel signal and output the signal, so that it is possible to detect an error in the pixel signal and correct the detected error portion at the time of processing the pixel signal. In this way, the finally output image can satisfy desired quality.

Then, in the imaging apparatus 1 according to the comparative example, the accuracy of correction is set such that the output image satisfies desired quality even in an environment where the image quality is assumed to be the worst under an environment where the imaging apparatus 1 is assumed to be used. In other words, the ECC generation unit 48 always operates to generate the error correcting code in which the output image satisfies the desired quality even under the environment in which the image quality is assumed to be the worst under the environment where the ECC generation unit 48 is assumed to be used. Specifically, the ECC generation unit 48 always generates an error correcting code having a predetermined data amount for a pixel signal having a predetermined data length.

Furthermore, in the imaging apparatus 1 of the comparative example, the gradation of the image, that is, the data amount of the pixel signal is also set such that the output image can satisfy the desired quality even in an environment where the image quality is assumed to be the worst under an environment where the imaging apparatus 1 of the comparative example is assumed to be used. In other words, the sensing unit always operates to output the pixel signal having a data amount in which the output image satisfies the desired quality even under the environment in which the image quality is assumed to be the worst under the environment where the sensing unit is assumed to be used.

Furthermore, in recent years, the number of elements of the imaging elements 100 mounted on the imaging apparatus 1 has increased due to development of a technology that enables miniaturization and the like of the imaging elements 100, and accordingly, the data amount of pixel signals acquired by one imaging apparatus 1 has dramatically increased. Furthermore, in recent years, since the imaging apparatus 1 can perform imaging at a high speed and has a high frame rate, the data amount of the pixel signal is continuously increasing.

Therefore, since the image processing unit (not illustrated) handles a large amount of data when processing sensing data, and it is difficult to avoid an increase in processing load. Furthermore, for example, in a smartphone, a monitoring camera, or the like on which the imaging apparatus 1 is mounted, the size and power consumption of the apparatus are limited, and thus it is strongly required to reduce the processing load.

Therefore, the present inventor has conducted intensive studies in view of such a situation. In the course of the study, the inventor of the present invention has found that the preset accuracy of correction is excessive specification in the case of using the imaging apparatus 1 according to the comparative example at a daily temperature since the error rate of the pixel signal changes according to the temperature of the sensing unit. Furthermore, based on such awareness, the present inventor has considered that, in a case where the imaging apparatus 1 is used at a daily temperature, the quality of the image can be maintained at a desired level even if the accuracy of correction is reduced, that is, the data amount of the error correcting code is reduced.

Furthermore, since the error rate of the pixel signal changes according to the temperature, the present inventor has conceived to dynamically change the accuracy of correction, that is, the data amount of the error correcting code to be generated according to the temperature. In addition, since it is difficult for the human eye to feel deterioration even if the image quality deteriorates to some extent, the present inventor has conceived that the data amount of the pixel signal is also dynamically changed according to the temperature. Then, from such an idea, the present inventor has created an embodiment of the present disclosure described below.

In the embodiment of the present disclosure created by the present inventor, as illustrated in FIG. 3, the data amount of the pixel signal and the error correcting code is dynamically changed by the temperature of the sensing unit (specifically, the pixel array unit 20). Specifically, in the embodiment of the present disclosure, for example, as illustrated on the left side of FIG. 3, the ECC generation units 48c and 48e are selected to reduce the data amount of the error correcting code and increase the data amount of the pixel signal in order to achieve high image gradation and normal correction accuracy under a low-temperature environment. On the other hand, in the embodiment of the present disclosure, for example, as illustrated on the right side of FIG. 3, the ECC generation units 48d and 48f are selected to increase the data amount of the error correcting code and reduce the data amount of the pixel signal in order to achieve low image gradation and high correction accuracy under a high-temperature environment. Note that, in the embodiment of the present disclosure, under a high-temperature environment, the amount of data may be reduced by converting the pixel signal into compressed data.

By doing so, in the embodiment of the present disclosure, since the amount of data of the error correcting code is large under a high-temperature environment in which noise or the like is likely to occur in the imaging element 100, the accuracy of correction is improved, and deterioration of image quality can be avoided. Furthermore, at this time, the data amount of the pixel signal decreases, and the image quality slightly deteriorates. However, since it is difficult for the human eye to feel deterioration, the image quality is substantially maintained. On the other hand, in a low-temperature environment, even if the amount of data of the error correcting code is small and the accuracy of correction is lowered, noise and the like are less likely to occur in the imaging element 100, so that an image with good quality can be obtained from the pixel signal. Therefore, in the embodiment of the present disclosure, by dynamically changing the data amount of the pixel signal and the error correcting code according to the temperature, it is possible to avoid an increase in the output data amount while maintaining the quality of the image. As a result, according to the embodiment of the present disclosure, it is possible to avoid an increase in the load of image processing.

Furthermore, in the embodiment of the present disclosure, for example, as illustrated on the left side of FIG. 3, under a low-temperature environment, the pixel signal is stored in the frame memory area 44 of the memory unit 42, and the error correcting code is stored in the parity bit area 46. On the other hand, under the high-temperature environment, the data amount of the pixel signal is reduced and the data amount of the error correcting code is increased. In this case, as illustrated on the left side of FIG. 3, the pixel signal is stored in a part of the frame memory area 44 of the memory unit 42, and the error correcting code is stored in a part of the frame memory area 44 and the parity bit area 46. That is, in the embodiment of the present disclosure, under the high-temperature environment, the parity bit area 46 is extended to a part of the frame memory area 44 by an amount corresponding to a decrease in the data amount of the pixel signal, and the error correcting code having a large data amount is stored in an extended parity bit area 70 obtained by the extension. Therefore, in the embodiment of the present disclosure, since the ratio between the area for storing the pixel signal and the area for storing the error correcting code in the memory unit 42 is dynamically changed according to the temperature, the memory unit 42 can be efficiently used. As a result, in the embodiment of the present disclosure, it is not necessary to add a memory element (not illustrated) to the memory unit 42 according to the data amount of the pixel signal and the error correcting code.

Hereinafter, details of embodiment of the present disclosure created by the present inventor will be sequentially described.

### 2. Embodiment

### 2.1 Detailed Configuration

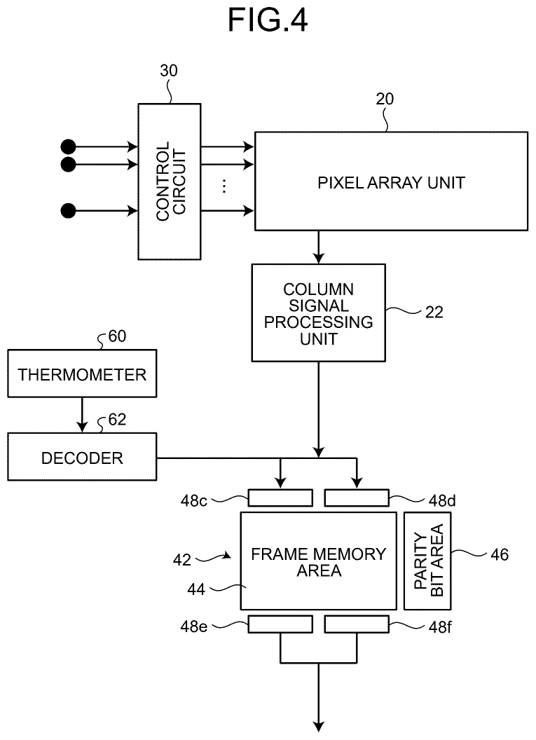

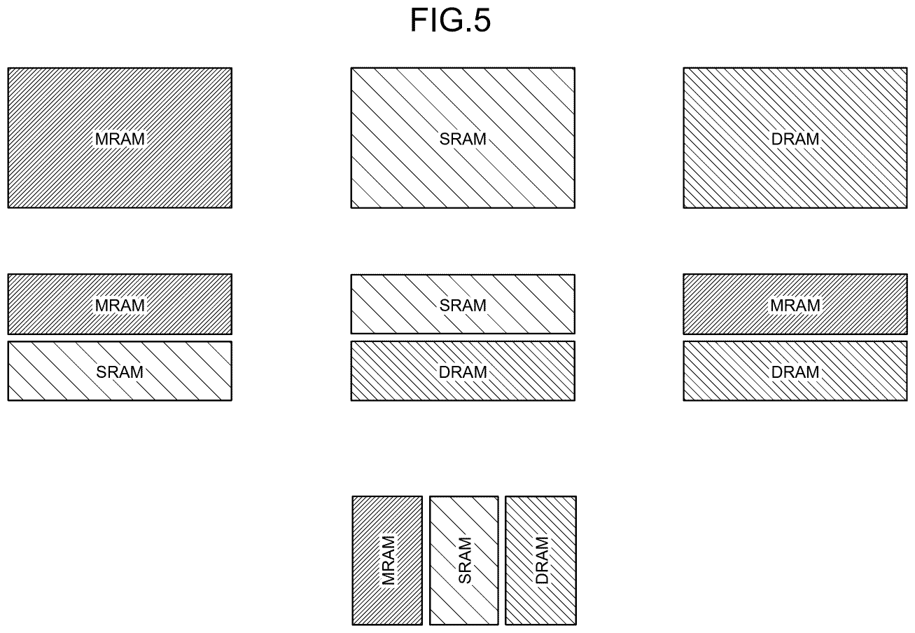

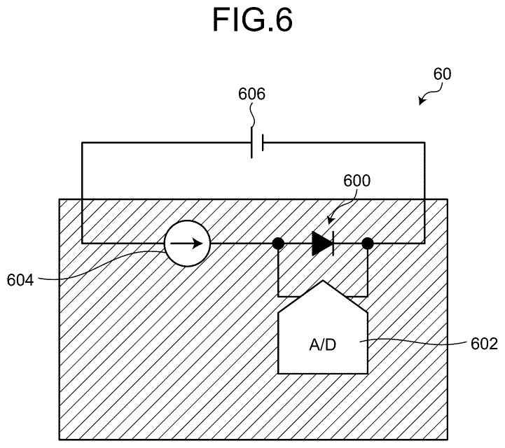

Next, a configuration example of an imaging apparatus (sensing data processing apparatus) 1 according to the embodiment of the present disclosure will be described with reference to FIGS. 4 to 6. FIG. 4 is an explanatory diagram illustrating a functional configuration example of the imaging apparatus 1 of the present embodiment, FIG. 5 is an explanatory diagram illustrating a functional configuration example of a memory unit 42 of the present embodiment, and FIG. 6 is an explanatory diagram illustrating a functional configuration example of a thermometer (temperature sensor) 60 of the present embodiment.

As illustrated in FIG. 4, the imaging apparatus (sensing data processing apparatus) 1 according to the present embodiment mainly includes a pixel array unit 20, a control circuit 30 that controls the pixel array unit 20 and the like (vertical drive circuit unit 21, horizontal drive circuit unit 23, and control circuit unit 25), a column signal processing unit (conversion unit) 22, a thermometer 60, a decoder (control unit) 62, an ECC generation unit (encoder) 48, and a memory unit 42. Hereinafter, a functional configuration of the imaging apparatus 1 according to the present embodiment will be sequentially described.

### Pixel Array Unit 20

The pixel array unit 20 includes a plurality of imaging elements 100 two-dimensionally arranged in an array. As described above, each imaging element 100 is an element that performs photoelectric conversion on incident light. The imaging element 100 outputs a pixel signal (sensing data) based on a charge obtained by the photoelectric conversion to a column signal processing unit 22 described later.

### Control Circuit 30

The control circuit 30 controls the above-described pixel array unit 20 and the like. Specifically, the control circuit 30 includes the above-described vertical drive circuit unit 21, horizontal drive circuit unit 23, control circuit unit 25, and the like.

### Column Signal Processing Unit 22

The column signal processing unit 22 performs signal processing on the pixel signal. Specifically, for example, the column signal processing unit 22 performs signal processing such as CDS and AD conversion in order to remove fixed pattern noise unique to pixels, and outputs a pixel signal (information data) subjected to the processing to the ECC generation unit 48 described later.

Furthermore, in the present embodiment, the sensing unit may dynamically change the gradation of the image to be output according to the temperature acquired by the thermometer 60 to be described later, in other words, may dynamically change the data amount of the pixel signal to be output. Specifically, in the present embodiment, for example, the data amount of the pixel signal is increased in order to obtain a high image gradation under a low-temperature environment, and the data amount of the pixel signal is reduced in order to obtain a low image gradation under a high-temperature environment. Note that, in the present embodiment, under a high-temperature environment, the amount of data may be reduced by converting the pixel signal into compressed data.

Furthermore, in the present embodiment, in a case where the gradation is reduced, part of the data of the pixel signal (for example, the least significant bit (LSB) having a small influence on the image quality) may be output as dummy data such as 0000 or a random number.

### ECC Generation Unit 48

The ECC generation unit 48 divides the pixel signal from the sensing unit into a certain length, performs error correcting encoding on the divided data on the basis of a predetermined rule, that is, calculates an error correcting code (redundant data), and adds the generated error correcting code to the original pixel signal. The added error correcting code can be used to detect an error from the acquired pixel signal and correct the detected error portion, for example, at the stage of processing of generating an image. In the present embodiment, as the error correcting code, for example, an existing error correcting code such as a horizontal/vertical parity code, a Hamming code, a Reed-Solomon code, a BCH code, or the like can be used.

Specifically, in the present embodiment, the ECC generation units 48c and 48d on the input side of the memory unit 42 that perform the error correcting coding when the pixel signal is acquired from the column signal processing unit 22 and the ECC generation units 48e and 48f on the output side of the memory unit 42 that perform the error correcting encoding when the pixel signal is output from the memory unit 42 are included. In the present embodiment, by doing so, not only an error by the imaging element 100 of the pixel array unit 20 and an error that occurs at the time of output from the pixel array unit 20 and the column signal processing unit 22 but also an error that occurs in a memory element (not illustrated) of the memory unit 42 can be handled.

Furthermore, in the present embodiment, the accuracy of correction is changed, that is, the data amount of the error correcting code is changed according to the temperature acquired by the thermometer 60 to be described later. Specifically, in the present embodiment, both the ECC generation unit 48 on the input side of the memory unit 42 and the ECC generation unit 48 on the output side of the memory unit 42 include a plurality of ECC generation units (encoding units) 48. Specifically, in the present embodiment, for example, the ECC generation units 48c and 48e are used to generate an error correcting code having a small data amount under a low-temperature environment, and the ECC generation units 48d and 48f are used to generate an error correcting code having a large data amount under a high-temperature environment.

### Memory Unit 42

The memory unit 42 includes, as described above, the frame memory area 44 for storing a pixel signal and the parity bit area 46 for storing an error correcting code (redundant data). In the present embodiment, the ratio between the area for storing the pixel signal and the area for storing the error correcting code in the memory unit 42 is dynamically changed according to the data amount of the pixel signal and the error correcting code to be stored, that is, according to the temperature acquired by the thermometer 60 to be described later. Specifically, in the present embodiment, for example, under a low-temperature environment, the pixel signal is stored in the frame memory area 44 of the memory unit 42, and the error correcting code is stored in the parity bit area 46. On the other hand, under the high-temperature environment, the data amount of the pixel signal is reduced and the data amount of the error correcting code is increased. In this case, the pixel signal is stored in a part of the frame memory area 44 of the memory unit 42, and the error correcting code is stored in a part of the frame memory area 44 and the parity bit area 46. Therefore, in the present embodiment, since the ratio between the area for storing the pixel signal and the area for storing the error correcting code in the memory unit 42 is dynamically changed according to the temperature, the memory unit 42 can be efficiently used. As a result, in the present embodiment, it is not necessary to add a memory element (not illustrated) to the memory unit 42 according to the data amount.

In addition, in the present embodiment, the type of the memory element constituting the memory unit 42 is not particularly limited. In the present embodiment, for example, as illustrated in the upper left of FIG. 5, the memory unit 42 may be a magnetoresistive random access memory (MRAM) constituted of a magnetic tunnel junction element (MTJ) element. Further, as illustrated in the upper center of FIG. 5, the memory unit 42 may be a static random access memory (SRAM) including transistors. Furthermore, as illustrated in the upper right of FIG. 5, the memory unit 42 may be a dynamic random access memory (DRAM) including a capacitor.

Furthermore, in the present embodiment, the memory unit 42 may include two of an MRAM, an SRAM, and a DRAM as illustrated in the middle part of FIG. 5, or may include an MRAM, an SRAM, and a DRAM as illustrated in the lower part of FIG. 5.

### Thermometer 60

The thermometer 60 is mounted on the pixel array unit (sensing apparatus) 20 side and can measure the temperature of the operating environment of the imaging element 100. For example, the thermometer 60 may be formed of a semiconductor temperature sensor provided on a substrate on which a plurality of imaging elements 100 is arranged. Specifically, as illustrated in FIG. 6, the thermometer 60 can include a diode 600 provided on a silicon substrate, and the diode 600 has a property that the potential difference between both ends decreases as the temperature decreases, and thus can be used as a semiconductor temperature sensor. More specifically, in the present embodiment, as illustrated in FIG. 6, the diode 600 is connected to a constant voltage source 606 and a constant current source 604, and an analog/digital (A/D) converter 602 that converts a potential difference into a digital signal is connected to both ends of the diode 600. The A/D converter 602 outputs a temperature measurement result (temperature data) converted into a digital signal to a decoder 62 described later. In the present embodiment, the thermometer 60 may be provided on the substrate provided with the pixel array unit 20 including the plurality of imaging elements 100, and by doing so, the volume of the imaging apparatus 1 can be reduced.

Note that, in the present embodiment, the thermometer 60 is not limited to being configured by a semiconductor temperature sensor provided on the substrate on which the pixel array unit 20 is provided, and may be configured as a separate object from the pixel array unit 20 provided in the vicinity of the pixel array unit 20.

Furthermore, in the present embodiment, the thermometer 60 is not limited to being provided only on the pixel array unit 20 side, and may also be provided on the memory unit 42 side. In this case, in a case where the memory unit 42 includes a memory element with retention force changing according to the temperature of the operating environment, the accuracy of correction can be changed according to the retention force of the memory element, that is, the data amount of the error correcting code can be changed.

### Decoder 62

The decoder 62 decodes the signal from the thermometer 60, and controls the ECC generation unit 48 on the basis of the decoded measurement result to dynamically change the correction accuracy. Specifically, the decoder 62 selects the ECC generation unit 48 to be used from the thermometer 60 on the basis of the measurement result, and changes the data amount of the error correcting code to be generated. Specifically, in the present embodiment, the decoder 62 selects the ECC generation units 48c and 48e and generates an error correcting code having a small data amount under a low-temperature environment lower than a preset threshold. On the other hand, in the present embodiment, the ECC generation units 48d and 48f are selected and an error correcting code having a large data amount is generated under a high-temperature environment higher than a preset threshold.

Further, the decoder 62 may dynamically change the gradation of the image output from the sensing unit on the basis of the measurement result from the thermometer 60, that is, may dynamically change the data amount of the pixel signal to be output. In the present embodiment, for example, the decoder 62 increases the data amount of the pixel signal in order to obtain a high image gradation under a low-temperature environment, and decreases the data amount of the pixel signal in order to obtain a low image gradation under a high-temperature environment. Note that, as described above, in the present embodiment, under a high-temperature environment, the amount of data may be reduced by converting the pixel signal into compressed data.

As described above, in the present embodiment, by dynamically changing the data amount of the pixel signal and the error correcting code according to the temperature, it is possible to avoid an increase in the output data amount while maintaining the quality of the image.

Furthermore, in the present embodiment, since the ratio between the area for storing the pixel signal and the area for storing the error correcting code in the memory unit 42 is dynamically changed as the data amount of the pixel signal and the error correcting code dynamically changes according to the temperature, the memory unit 42 can be efficiently used. In other words, in the present embodiment, the decoder 62 can optimize the use efficiency of the memory unit 42 while maintaining the quality of the image by performing control in consideration of the balance between the image quality and the error occurrence frequency according to the temperature.

Note that, in the present embodiment, the imaging apparatus 1 is not limited to the configuration and form illustrated in FIGS. 4 to 6, and may be configured by combining a plurality of separate devices.

### 2.2 Operation Example of Imaging Apparatus

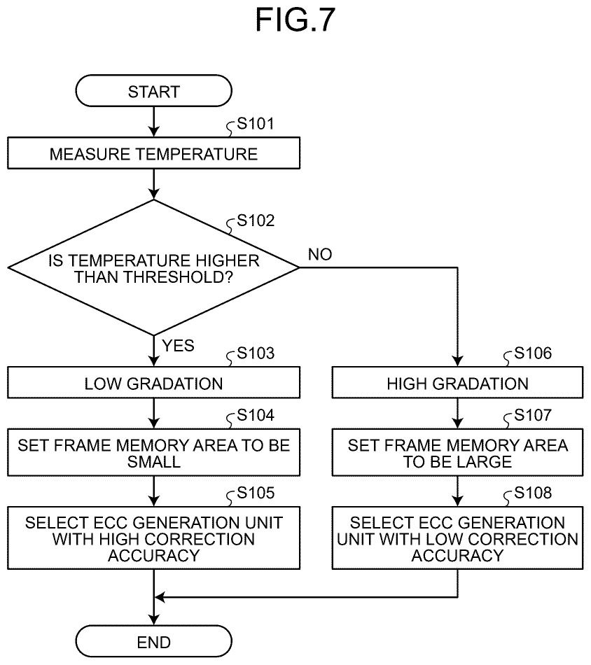

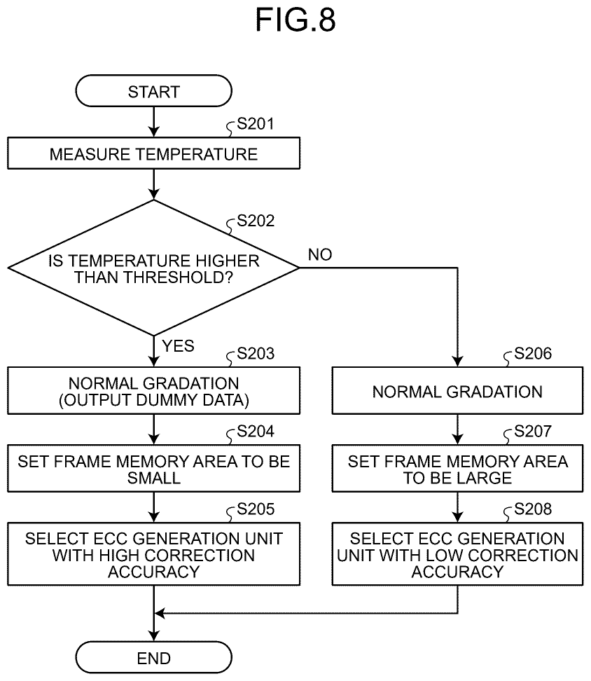

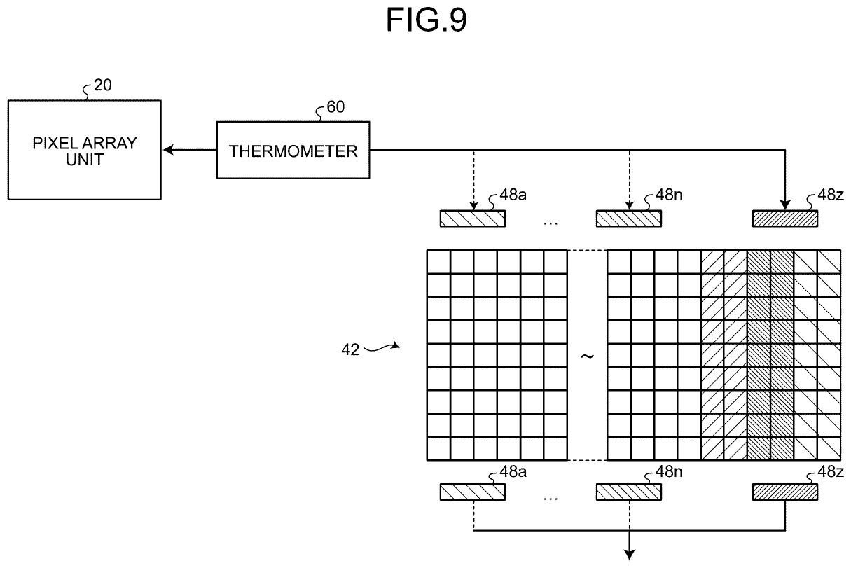

Next, an operation example of the imaging apparatus 1 according to the present embodiment will be described with reference to FIGS. 7 to 9. FIGS. 7 and 8 are flowcharts illustrating an operation example of the imaging apparatus according to the present embodiment, and FIG. 9 is an explanatory diagram illustrating an outline of a modification of the present embodiment.

First, as illustrated in FIG. 7, the imaging apparatus 1 measures the temperature of the operating environment of the imaging element 100 (step S101). Next, the imaging apparatus 1 compares the temperature measured in step S101 with a preset threshold (step S102). Then, in a case where the temperature is higher than the threshold (step S102: Yes), the imaging apparatus 1 proceeds to the processing of step S103. On the other hand, in a case where the temperature is not higher than the threshold (step S102: No), the imaging apparatus 1 proceeds to the processing of step S106.

Next, the imaging apparatus 1 controls the data amount of the pixel signal to be output to be small so that the image quality has a low gradation (step S103), and sets an area to be used as the frame memory area 44 in which the pixel signal is stored in the memory unit 42 to be small (step S104). Next, the imaging apparatus 1 selects the ECC generation unit 48 with high correction accuracy and increases the data amount of the error correcting code to be generated (step S105). Further, the imaging apparatus 1 stores the generated error correcting code in the parity bit area 46 and a part of the frame memory area 44 of the memory unit 42, and ends the processing.

Furthermore, the imaging apparatus 1 controls the data amount of the pixel signal to be output to be large so that the image quality has a high gradation (step S106), and sets an area to be used as the frame memory area 44 in which the pixel signal is stored in the memory unit 42 to be large (step S107). Next, the imaging apparatus 1 selects the ECC generation unit 48 with low correction accuracy and decreases the data amount of the error correcting code to be generated (step S105). Furthermore, the imaging apparatus 1 stores the generated error correcting code in the parity bit area 46 of the memory unit 42, and ends the processing.

Furthermore, in the present embodiment, the imaging apparatus 1 may perform an operation as illustrated in FIG. 8.

First, as illustrated in FIG. 8, the imaging apparatus 1 measures the temperature of the operating environment of the imaging element 100 (step S201). Next, the imaging apparatus 1 compares the measured temperature with a preset threshold (step S202). Then, in a case where the temperature is higher than the threshold (step S202: Yes), the imaging apparatus 1 proceeds to the processing of step S203. On the other hand, in a case where the temperature is not higher than the threshold (step S202: No), the imaging apparatus 1 proceeds to the processing of step S206.

Next, the imaging apparatus 1 sets the image quality to normal gradation, and performs control so that dummy data is included in a part of the pixel signal to be output (step S203). Furthermore, the imaging apparatus 1 sets an area to be used as the frame memory area 44 in which the pixel signal is stored in the memory unit 42 to be small (step S204). Next, the imaging apparatus 1 selects the ECC generation unit 48 with high correction accuracy and increases the data amount of the error correcting code to be generated (step S205). Further, the imaging apparatus 1 stores the generated error correcting code in the parity bit area 46 and a part of the frame memory area 44 of the memory unit 42, and ends the processing.

Furthermore, the imaging apparatus 1 sets the image quality to normal gradation, and controls the data amount of the pixel signal to be output to be increased (step S206). Furthermore, the imaging apparatus 1 sets an area to be used as the frame memory area 44 in which the pixel signal is stored in the memory unit 42 to be large (step S207). Next, the imaging apparatus 1 selects the ECC generation unit 48 with low correction accuracy and decreases the data amount of the error correcting code to be generated (step S205). Furthermore, the imaging apparatus 1 stores the generated error correcting code in the parity bit area 46 of the memory unit 42, and ends the processing.

Furthermore, in the present embodiment, as described above, the present invention is not limited to dynamically changing the data amount of the pixel signal and the error correcting code to two levels according to the temperature. In the present embodiment, for example, by setting a plurality of thresholds in advance, the data amount of the pixel signal and the error correcting code may be dynamically changed to three or more levels according to the temperature. In such a case, as illustrated in FIG. 9, the ECC generation units 48a, . . . 48n, and 48z may be prepared by the number of levels, and the ECC generation unit 48 to be used may be selected according to the temperature.

More specifically, for example, in a case where the temperature is 25° C. or lower, the ECC generation unit 48 that generates a two-bit error correcting code for a pixel signal of a predetermined data amount is selected. In addition, for example, in a case where the temperature is between 25° C. and 60° C., the ECC generation unit 48 that generates a four-bit error correcting code for a pixel signal of a predetermined data amount is selected. Furthermore, for example, in a case where the temperature is 60° C. or higher, the ECC generation unit 48 that generates a six-bit error correcting code for a pixel signal of a predetermined data amount is selected.

### 2.3 Stacked Structure Example

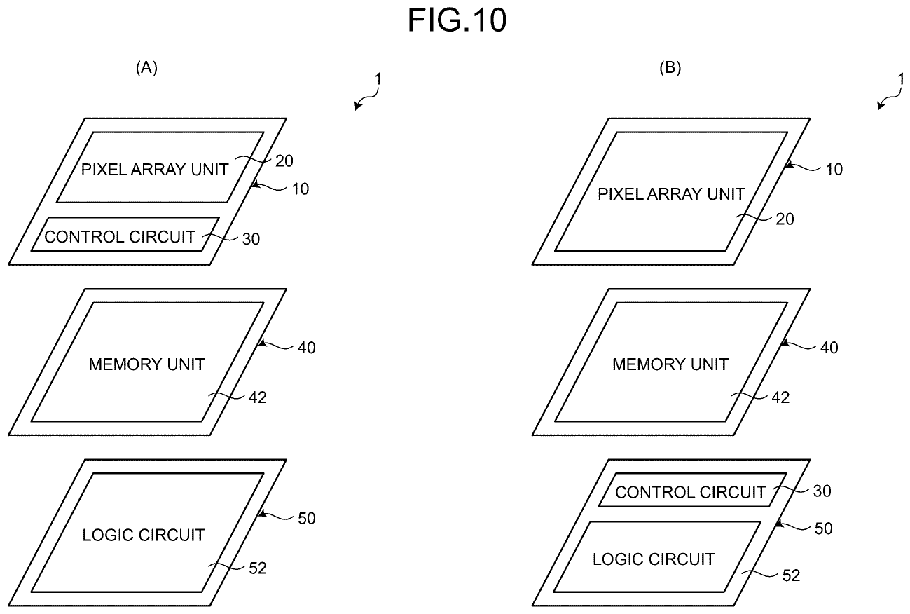

Furthermore, the imaging apparatus 1 according to the present embodiment may be configured by stacking three layers or two layers. Here, an example of a stacked structure of the imaging apparatus 1 will be described with reference to FIG. 10. FIG. 10 is an explanatory diagram illustrating a stacked configuration example of the imaging apparatus of the present embodiment.

For example, FIG. 10A illustrates a stacked structure in which a substrate (first substrate) 10 on which a pixel array unit 20 and a control circuit 30 are provided, a substrate (second substrate) 40 on which a memory unit 42 is provided, and a substrate (third substrate) 50 on which a logic circuit 52 that performs signal processing is provided are stacked as the imaging apparatus 1.

In addition, for example, FIG. 10B illustrates a stacked structure in which a substrate (first substrate) 10 on which a pixel array unit 20 is provided, a substrate (second substrate) 40 on which a memory unit 42 is provided, and a substrate (third substrate) 50 on which a control circuit 30 and a logic circuit 52 are provided are stacked as the imaging apparatus 1.

Note that the present embodiment is not limited to such a three-layer stacked structure in which three substrates are stacked, and may be a two-layer stacked structure in which two substrates are stacked, or all functional units may be provided on one substrate, and is not particularly limited.

### 3. Summary

As described above, in the embodiment of the present disclosure, by dynamically changing the data amount of the pixel signal and the error correcting code according to the temperature, it is possible to avoid an increase in the output data amount while maintaining the quality of the image. Furthermore, in the present embodiment, since the ratio between the area for storing the pixel signal and the area for storing the error correcting code in the memory unit 42 is dynamically changed as the data amount of the pixel signal and the error correcting code dynamically changes according to the temperature, the memory unit 42 can be efficiently used. In other words, in the present embodiment, the use efficiency of the memory unit 42 can be optimized while maintaining the quality of the image by performing control in consideration of the balance between the image quality and the error occurrence frequency according to the temperature.

Furthermore, the imaging apparatus 1 according to the embodiment of the present disclosure can be manufactured by using a method, an apparatus, and conditions used for manufacturing a general semiconductor device. That is, the imaging apparatus 1 according to the present embodiment can be manufactured using an existing semiconductor device manufacturing process.

Examples of the above-described method include a physical vapor deposition (PVD) method, a chemical vapor deposition (CVD) method, and an atomic layer deposition (ALD) method. Examples of the PVD method include a vacuum vapor deposition method, an electron beam (EB) vapor deposition method, various sputtering methods (magnetron sputtering method, radio frequency (RF)-direct current (DC) coupled bias sputtering method, electron cyclotron resonance (ECR) sputtering method, counter target sputtering method, high frequency sputtering method, and the like), an ion plating method, a laser ablation method, a molecular beam epitaxy (MBE) method, and a laser transfer method. In addition, examples of the CVD method include a plasma CVD method, a thermal CVD method, an organic metal (MO) CVD method, and a photo CVD method. Moreover, as other methods, there are various types of printing methods such as an electrolytic plating method and an electroless plating method, a spin coating method, a dipping method, a casting method, a micro contact printing method, a drop casting method, a screen printing method, an ink-jet printing method, an offset printing method, a gravure printing method, and a flexographic printing method. There are various types of coating methods such as a stamp method, a spray method, an air doctor coating method, a blade coating method, a rod coating method, a knife coating method, a squeeze coating method, a reverse roll coating method, a transfer roll coating method, a gravure coating method, a kiss coating method, a cast coating method, a spray coating method, a slit orifice coating method, and a calendar coating method. Also, examples of patterning methods include chemical etching such as a shadow mask, a laser transfer, and a photolithography, and a physical etching such as an ultraviolet ray and a laser beam. In addition, examples of the planarization technique include a chemical mechanical polishing (CMP) method, a laser planarizing method, a reflow method, and the like.

In the above description, a case where the embodiment of the present disclosure is applied to the imaging apparatus 1 has been described as an example, but the embodiment of the present disclosure is not limited to being applied to the imaging apparatus 1 described above. The embodiment of the present disclosure is applicable to any sensing apparatus including a plurality of sensor elements arranged in a two-dimensional array. For example, the embodiment of the present disclosure can be applied to a sensing apparatus having a pressure detection element that is worn on a part of a human body and detects a pressure applied to the part of the body. Furthermore, the embodiment of the present disclosure can be applied to, for example, a sensing apparatus that is mounted on a part of a human head and includes a magnetic detection element that detects electroencephalograms. Furthermore, the imaging apparatus 1 is not limited to an imaging apparatus that detects visible light, and may be a time of flight (ToF) sensor or the like that detects infrared rays or the like reflected from an object, and the wavelength of light to be detected is not particularly limited.

Note that the tendency of an error that occurs with respect to temperature varies depending on the type of the sensor element. Therefore, in a case where the present embodiment is applied, depending on the type of the sensor element, in a case where the temperature is less than the predetermined threshold value, control may be performed such that the data amount of the information data is reduced and the data amount of the error correcting code is increased. That is, in the embodiment of the present disclosure, as described above, the control is not limited to the control of decreasing the data amount of the information data and increasing the data amount of the error correcting code in a case where the temperature is equal to or higher than the predetermined threshold.

### 4. Application Example

The technology according to the present disclosure (present technology) can be further applied to various products. Hereinafter, application examples of the technology according to the present disclosure will be described.

### 4.1 Application Example to Monitoring Camera

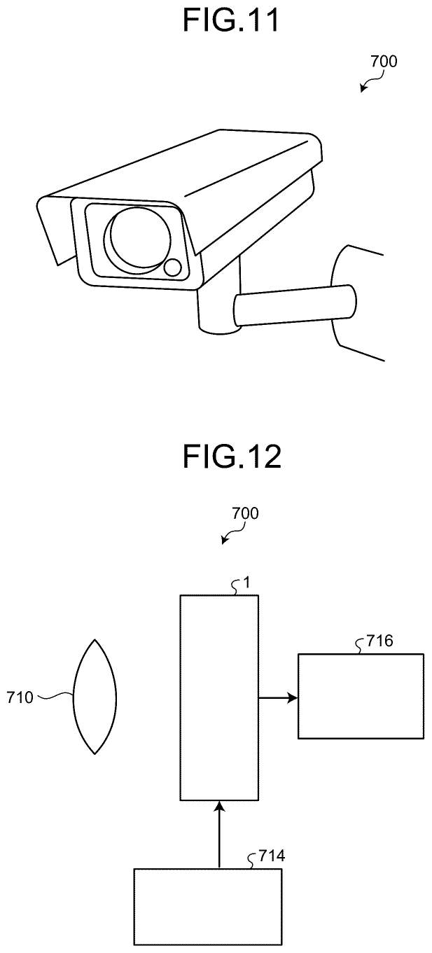

For example, the technology according to the present disclosure may be applied to a camera or the like. Therefore, a configuration example of a monitoring camera 700 as an electronic device to which the present technology is applied will be described with reference to FIGS. 11 and 12. FIG. 11 is an explanatory diagram illustrating an example of an appearance of the monitoring camera 700 to which the technology according to the present disclosure (the present technology) can be applied, and FIG. 12 is an explanatory diagram illustrating an example of a schematic functional configuration of the monitoring camera 700 to which the technology according to the present disclosure (the present technology) can be applied.

The monitoring camera 700 has an appearance as illustrated in FIG. 11, and may be installed outdoors. Therefore, since the monitoring camera 700 may be used in an environment with a large temperature difference, by applying the technology of the present disclosure to the monitoring camera 700, even if there is a temperature difference, it is possible to suppress an increase in the amount of data while suppressing deterioration in image quality.

As illustrated in FIG. 12, the monitoring camera 700 includes an imaging apparatus 1, an optical lens 710, a drive circuit unit 714, and a signal processing circuit unit 716. The optical lens 710 forms an image of image light (incident light) from a subject on an imaging surface of the imaging apparatus 1. As a result, signal charges are accumulated in the imaging element 100 of the imaging apparatus 1 for a certain period. The drive circuit unit 714 supplies a drive signal for controlling a signal transfer operation and the like of the imaging apparatus 1 to these. That is, the imaging apparatus 1 performs signal transfer on the basis of the drive signal (timing signal) supplied from the drive circuit unit 714. The signal processing circuit unit 716 performs various types of signal processing. For example, the signal processing circuit unit 716 outputs the video signal subjected to the signal processing to, for example, a storage medium (not illustrated) such as a memory, or to a display unit (not illustrated).

The configuration example of the monitoring camera 700 has been described above. Each of the above-described components may be configured using a general-purpose member, or may be configured by hardware specialized for the function of each component. Such a configuration can be appropriately changed according to the technical level at the time of implementation.

### 4.2 Application Example to Smartphone

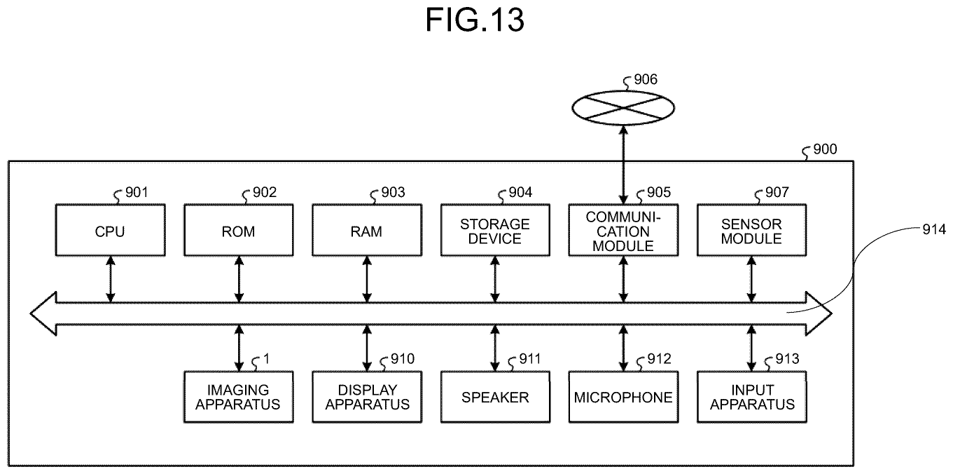

For example, the technology according to the present disclosure may be applied to a smartphone or the like. Therefore, a configuration example of a smartphone 900 as an electronic device to which the present technology is applied will be described with reference to FIG. 13. FIG. 13 is a block diagram illustrating an example of a functional configuration of the smartphone 900 to which the technology according to the present disclosure (present technology) can be applied.

As illustrated in FIG. 13, the smartphone 900 includes a central processing unit (CPU) 901, a read only memory (ROM) 902, and a random access memory (RAM) 903. In addition, the smartphone 900 includes a storage device 904, a communication module 905, and a sensor module 907. Furthermore, the smartphone 900 includes an imaging apparatus 1, a display apparatus 910, a speaker 911, a microphone 912, an input apparatus 913, and a bus 914. Furthermore, the smartphone 900 may include a processing circuit such as a digital signal processor (DSP) instead of or in addition to the CPU 901.

The CPU 901 functions as an arithmetic processing device and a control device, and controls the overall operation in the smartphone 900 or a part thereof according to various programs recorded in the ROM 902, the RAM 903, the storage device 904, or the like. The ROM 902 stores programs, operation parameters, and the like used by the CPU 901. The RAM 903 temporarily stores programs used in execution of the CPU 901, parameters that appropriately change in the execution, and the like. The CPU 901, the ROM 902, and the RAM 903 are mutually connected by the bus 914. In addition, the storage device 904 is a device for data storage formed as an example of the storage unit of the smartphone 900. The storage device 904 may include, for example, a magnetic storage device such as a hard disk drive (HDD), a semiconductor storage device, an optical storage device, or the like. The storage device 904 stores programs executed by the CPU 901, various data, various data acquired from the outside, and the like.

The communication module 905 is a communication interface including, for example, a communication device for connecting to the communication network 906. The communication module 905 may be, for example, a communication card for wired or wireless local area network (LAN), Bluetooth (registered trademark), wireless universal serial bus (WUSB), or the like. Furthermore, the communication module 905 may also be a router for optical communication, a router for asymmetric digital subscriber line (ADSL), a modem for various communications, or the like. The communication module 905 transmits and receives signals and the like to and from the Internet and other communication devices using a predetermined protocol such as Transmission Control Protocol (TCP)/Internet Protocol (IP). Furthermore, the communication network 906 connected to the communication module 905 is a network connected in a wired or wireless manner, and is, for example, the Internet, a home LAN, infrared communication, satellite communication, or the like.

The sensor module 907 includes, for example, various sensors such as a motion sensor (for example, an acceleration sensor, a gyro sensor, a geomagnetic sensor, or the like), a biological information sensor (for example, a pulse sensor, a blood pressure sensor, a fingerprint sensor, or the like), or a position sensor (for example, a global navigation satellite system (GNSS) receiver or the like).

The imaging apparatus 1 is provided on the surface of the smartphone 900, and can image an object or the like located on the back side or the front side of the smartphone 900. Specifically, the technology according to the present disclosure (present technology) may be applied to the imaging apparatus 1. Furthermore, the imaging apparatus 1 can further include an optical system mechanism (not illustrated) including an imaging lens, a zoom lens, a focus lens, and the like, and a drive system mechanism (not illustrated) that controls the operation of the optical system mechanism.

The display apparatus 910 is provided on the surface of the smartphone 900, and can be, for example, a display apparatus such as a liquid crystal display (LCD) or an organic electro luminescence (EL) display. The display apparatus 910 can display an operation screen, a captured image acquired by the above-described imaging apparatus 1, and the like.

The speaker 911 can output, for example, a voice on the call, a voice accompanying the video content displayed by the display apparatus 910 described above, and the like to the user.

The microphone 912 can collect, for example, a voice of the user on the call, a voice including a command to activate a function of the smartphone 900, and a voice in a surrounding environment of the smartphone 900.

The input apparatus 913 is a device operated by the user, such as a button, a keyboard, a touch panel, or a mouse. The input apparatus 913 includes an input control circuit that generates an input signal on the basis of information input by the user and outputs the input signal to the CPU 901. By operating the input apparatus 913, the user can input various data to the smartphone 900 and give an instruction on a processing operation.

The configuration example of the smartphone 900 has been described above. Each of the above-described components may be configured using a general-purpose member, or may be configured by hardware specialized for the function of each component. Such a configuration can be appropriately changed according to the technical level at the time of implementation.

Since the smartphone 900 has limitations on the size and power consumption of the device, it is strongly required to lower the processing load. Therefore, by applying the technology of the present disclosure to the smartphone 900, it is possible to suppress an increase in the amount of data while suppressing deterioration in image quality.

### 4.3 Application Example to Mobile Body

For example, the technology according to the present disclosure may be realized as devices mounted on any types of mobile bodies such as automobiles, electric vehicles, hybrid electric vehicles, motorcycles, bicycles, personal mobilities, airplanes, drones, ships, and robots.

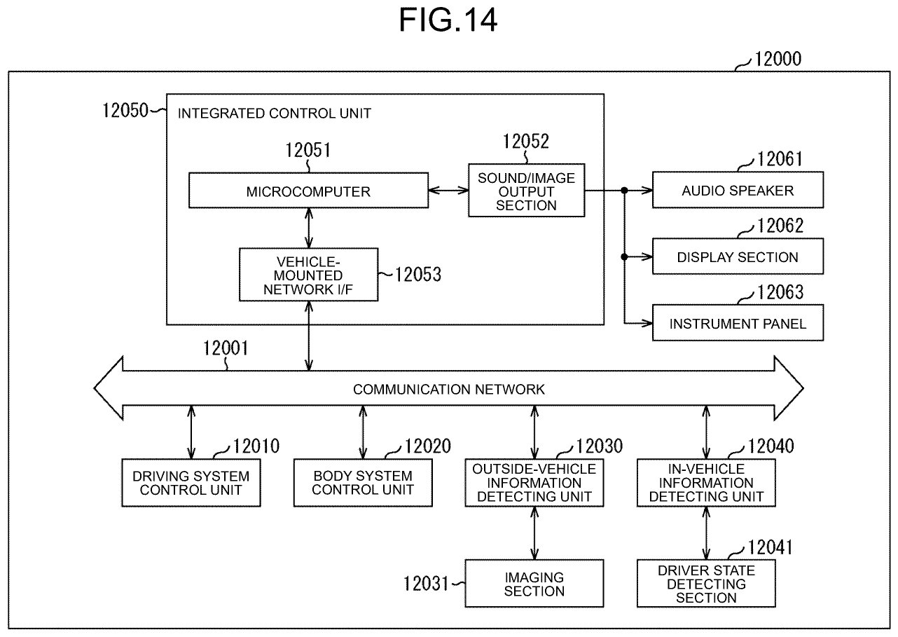

FIG. 14 is a block diagram depicting an example of schematic configuration of a vehicle control system as an example of a mobile body control system to which the technology according to an embodiment of the present disclosure can be applied.

The vehicle control system 12000 includes a plurality of electronic control units connected to each other via a communication network 12001. In the example depicted in FIG. 14, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 14, an audio speaker 12061, a display section 12062, and an instrument panel 12063 are illustrated as the output device. The display section 12062 may, for example, include at least one of an on-board display and a head-up display.

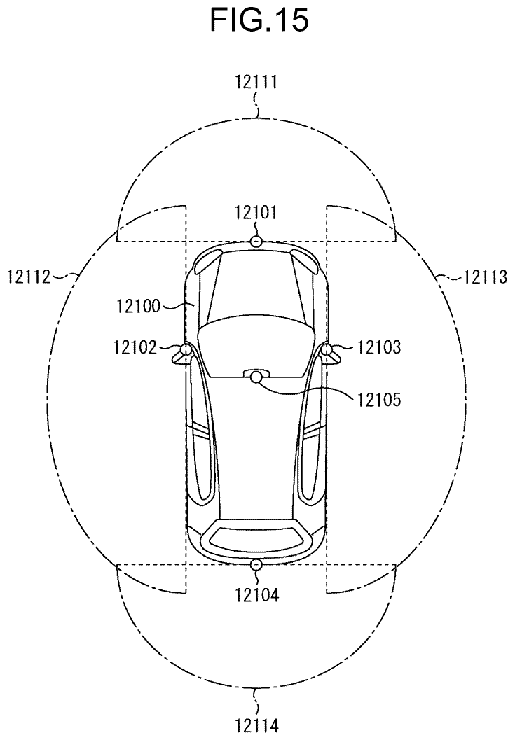

FIG. 15 is a diagram depicting an example of the installation position of the imaging section 12031.

In FIG. 15, the imaging section 12031 includes imaging sections 12101, 12102, 12103, 12104, and 12105.

The imaging sections 12101, 12102, 12103, 12104, and 12105 are, for example, disposed at positions on a front nose, sideview mirrors, a rear bumper, and a back door of a vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Incidentally, FIG. 15 depicts an example of photographing ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

In the above, an example of the vehicle control system to which the technology related to the present disclosure can be applied is described. The technology according to the present disclosure can be applied to, for example, the imaging section 12031 within the above-described configuration. For example, the imaging section 12031 may be used in an environment with a large temperature difference. Therefore, by applying the technology of the present disclosure to the imaging section 12031, even if there is a temperature difference, it is possible to suppress an increase in the amount of data while suppressing deterioration in image quality.

### 5. Supplement

Although the preferred embodiments of the present disclosure have been described above with reference to the accompanying drawings, the technical scope of the present disclosure is not limited to the above examples. It is obvious that a person skilled in the art may find various alterations and modifications within the scope of the appended claims, and it should be understood that they will naturally come under the technical scope of the present disclosure.

Furthermore, the effects described in this specification are merely illustrative or exemplified effects, and are not limitative. That is, with or in the place of the above effects, the technology according to the present disclosure may achieve other effects that are clear to those skilled in the art from the description of this specification.

Note that the present technology can also have the following configurations.
(1) A sensing data processing apparatus comprising:
   a conversion unit that acquires sensing data output from a sensing unit including a plurality of sensor elements arranged in a two-dimensional array, converts the sensing data into digital data, and outputs the digital data as information data;
   an encoder that performs error correcting encoding on the information data and generates redundant data; and
   a control unit that dynamically changes data amounts of the information data and the redundant data on a basis of temperature data acquired from a temperature sensor provided in the sensing unit.
(2) The sensing data processing apparatus according to (1), wherein the encoder includes a plurality of encoding units having different data amounts of the redundant data to be generated.
(3) The sensing data processing apparatus according to (1) or (2), further comprising
   a memory unit including a frame memory area in which the information data is stored and a parity bit area in which the redundant data is stored, wherein
   the memory unit dynamically changes a ratio between an area used as the frame memory area and an area used as the parity bit area on a basis of the temperature data.
(4) The sensing data processing apparatus according to any one of (1) to (3), wherein the conversion unit outputs dummy data together with the information data according to the temperature data.
(5) The sensing data processing apparatus according to any one of (1) to (4), wherein
   the control unit decreases the data amount of the information data and increases the data amount of the redundant data in a case where the temperature data is equal to or more than a predetermined threshold.
(6) The sensing data processing apparatus according to any one of (1) to (4), wherein
   the control unit decreases the data amount of the information data and increases the data amount of the redundant data in a case where the temperature data is less than a predetermined threshold.
(7) The sensing data processing apparatus according to any one of (1) to (4), wherein the control unit adjusts the data amounts of the information data and the redundant data in three or more levels according to the temperature data.
(8) The sensing data processing apparatus according to any one of (1) to (7), wherein the temperature sensor includes a semiconductor temperature sensor provided on a substrate on which the plurality of sensor elements is arranged.
(9) The sensing data processing apparatus according to (3), wherein
   the control unit dynamically changes the data amount of the redundant data on a basis of temperature data acquired from another temperature sensor provided in the memory unit.
(10) The sensing data processing apparatus according to (9), further comprising the sensing unit.
(11) The sensing data processing apparatus according to (10), further comprising:
   a first substrate on which the sensing unit is provided; and
   a second substrate provided with the memory unit and stacked with the first substrate.
(12) The sensing data processing apparatus according to (11), further comprising a third substrate on which at least one of the conversion unit, the encoder, and the control unit is provided and which is stacked with the first and second substrates.
(13) The sensing data processing apparatus according to (3), wherein the memory unit includes at least one of an MRAM, an SRAM, and a DRAM.
(14) The sensing data processing apparatus according to any one of (1) to (13), wherein the sensor element is an imaging element that detects light.
(15) The sensing data processing apparatus according to any one of (1) to (13), wherein the sensor element is a magnetic detection element that detects magnetism.
(16) The sensing data processing apparatus according to any one of (1) to (13), wherein the sensor element is a pressure detection element that detects pressure.
(17) A method for sensing data processing, comprising:
   by a sensing data processing apparatus,
   acquiring sensing data output from a sensing unit including a plurality of sensor elements arranged in a two-dimensional array, converting the sensing data into digital data, and outputting the digital data as information data;
   performing error correcting encoding on the information data and generating redundant data; and
   dynamically changing data amounts of the information data and the redundant data on a basis of temperature data acquired from a temperature sensor provided in the sensing unit.
(18) An electronic device on which a sensing data processing apparatus is mounted, wherein
   the sensing data processing apparatus includes:
   a conversion unit that acquires sensing data output from a sensing unit including a plurality of sensor elements arranged in a two-dimensional array, converts the sensing data into digital data, and outputs the digital data as information data;
   an encoder that performs error correcting encoding on the information data and generates redundant data; and
   a control unit that dynamically changes data amounts of the information data and the redundant data on a basis of temperature data acquired from a temperature sensor provided in the sensing unit.

### REFERENCE SIGNS LIST

1 IMAGING APPARATUS
10, 40, 50 SUBSTRATE
20 PIXEL ARRAY UNIT
21 VERTICAL DRIVE CIRCUIT UNIT
22 COLUMN SIGNAL PROCESSING UNIT
23 HORIZONTAL DRIVE CIRCUIT UNIT
24 OUTPUT CIRCUIT UNIT
25 CONTROL CIRCUIT UNIT
26 PIXEL DRIVE LINE
27 VERTICAL SIGNAL LINE
28 HORIZONTAL SIGNAL LINE
29 INPUT/OUTPUT TERMINAL
30 CONTROL CIRCUIT
42 MEMORY UNIT
44 FRAME MEMORY AREA
46 PARITY BIT AREA
48, 48a, 48b, 48c, 48d, 48e, 48f, 48n, 48z ECC GENERATION UNIT
52 LOGIC CIRCUIT
60 THERMOMETER
62 DECODER
70 EXTENDED PARITY BIT AREA
100 IMAGING ELEMENT
600 DIODE
602 A/D CONVERTER
604 CONSTANT CURRENT SOURCE
606 CONSTANT VOLTAGE SOURCE
700 MONITORING CAMERA
710 OPTICAL LENS
714 DRIVE CIRCUIT UNIT
716 SIGNAL PROCESSING CIRCUIT UNIT
900 SMARTPHONE
901 CPU
902 ROM
903 RAM
904 STORAGE DEVICE
905 COMMUNICATION MODULE
906 COMMUNICATION NETWORK
907 SENSOR MODULE
910 DISPLAY APPARATUS
911 SPEAKER
912 MICROPHONE
913 INPUT APPARATUS
914 BUS

1. A sensing data processing apparatus comprising:
a conversion unit that acquires sensing data output from a sensing unit including a plurality of sensor elements arranged in a two-dimensional array, converts the sensing data into digital data, and outputs the digital data as information data;
an encoder that performs error correcting encoding on the information data and generates redundant data; and
a control unit that dynamically changes data amounts of the information data and the redundant data on a basis of temperature data acquired from a temperature sensor provided in the sensing unit.

2. The sensing data processing apparatus according to claim 1, wherein the encoder includes a plurality of encoding units having different data amounts of the redundant data to be generated.

3. The sensing data processing apparatus according to claim 1, further comprising
a memory unit including a frame memory area in which the information data is stored and a parity bit area in which the redundant data is stored, wherein
the memory unit dynamically changes a ratio between an area used as the frame memory area and an area used as the parity bit area on a basis of the temperature data.

4. The sensing data processing apparatus according to claim 1, wherein the conversion unit outputs dummy data together with the information data according to the temperature

5. The sensing data processing apparatus according to claim 1, wherein
the control unit decreases the data amount of the information data and increases the data amount of the redundant data in a case where the temperature data is equal to or more than a predetermined threshold.

6. The sensing data processing apparatus according to claim 1, wherein
the control unit decreases the data amount of the information data and increases the data amount of the redundant data in a case where the temperature data is less than a predetermined threshold.

7. The sensing data processing apparatus according to claim 1, wherein the control unit adjusts the data amounts of the information data and the redundant data in three or more levels according to the temperature data.

8. The sensing data processing apparatus according to claim 1, wherein the temperature sensor includes a semiconductor temperature sensor provided on a substrate on which the plurality of sensor elements is arranged.

9. The sensing data processing apparatus according to claim 3, wherein
the control unit dynamically changes the data amount of the redundant data on a basis of temperature data acquired from another temperature sensor provided in the memory unit.

10. The sensing data processing apparatus according to claim 9, further comprising the sensing unit.

11. The sensing data processing apparatus according to claim 10, further comprising:
a first substrate on which the sensing unit is provided; and
a second substrate provided with the memory unit and stacked with the first substrate.

12. The sensing data processing apparatus according to claim 11, further comprising a third substrate on which at least one of the conversion unit, the encoder, and the control unit is provided and which is stacked with the first and second substrates.

13. The sensing data processing apparatus according to claim 3, wherein the memory unit includes at least one of an MRAM, an SRAM, and a DRAM.

14. The sensing data processing apparatus according to claim 1, wherein the sensor element is an imaging element that detects light.

15. The sensing data processing apparatus according to claim 1, wherein the sensor element is a magnetic detection element that detects magnetism.

16. The sensing data processing apparatus according to claim 1, wherein the sensor element is a pressure detection element that detects pressure.

17. A method for sensing data processing, comprising:
by a sensing data processing apparatus,
acquiring sensing data output from a sensing unit including a plurality of sensor elements arranged in a two-dimensional array, converting the sensing data into digital data, and outputting the digital data as information data;
performing error correcting encoding on the information data and generating redundant data; and
dynamically changing data amounts of the information data and the redundant data on a basis of temperature data acquired from a temperature sensor provided in the sensing unit.

18. An electronic device on which a sensing data processing apparatus is mounted, wherein
the sensing data processing apparatus includes:
a conversion unit that acquires sensing data output from a sensing unit including a plurality of sensor elements arranged in a two-dimensional array, converts the sensing data into digital data, and outputs the digital data as information data;
an encoder that performs error correcting encoding on the information data and generates redundant data; and
a control unit that dynamically changes data amounts of the information data and the redundant data on a basis of temperature data acquired from a temperature sensor provided in the sensing unit.
